(19) United States
(12) Patent Application Publication
(10) Pub. No.: US 2024/0047807 A1
(43) Pub. Date: Feb. 8, 2024

(54) BATTERY PACK FOR POWERING AN ELECTRIC DEVICE

(71) Applicant: Nanjing Chervon Industry Co., Ltd., Nanjing (CN)

(72) Inventors: Yunfei Gao, Nanjing (CN); Toshinari Yamaoka, Nanjing (CN); Jiajun Huang, Nanjing (CN); Yuexiang Zhang, Nanjing (CN); Liang Chen, Nanjing (CN); Zhiyong Wu, Nanjing (CN)

(21) Appl. No.: 18/358,390

(22) Filed: Jul. 25, 2023

(30) Foreign Application Priority Data
Aug. 5, 2022 (CN) 202210936764.6

(51) Int. Cl. H01M 50/244; H01M 10/052; H01M 50/213; H01M 50/296; H01M 50/256

(52) U.S. Cl. CPC H01M 50/244; H01M 10/052; H01M 50/213; H01M 50/296; H01M 50/256; H01M 2220/20

(57) ABSTRACT

A battery pack for powering an outdoor moving includes: a housing mounted to the outdoor moving device and supported by the outdoor moving device; and a cell module mounted to the housing and including multiple cells. A cell is cylindrical and the diameter of the cell is greater than or equal to 3 cm.

### RELATED APPLICATION INFORMATION

This application claims the benefit under 35 U.S.C. § 119(a) of Chinese Patent Application No. 202210936764.6, filed on Aug. 5, 2022, which application is incorporated herein by reference in its entirety.

### BACKGROUND

With the development of battery technology, power tools are gradually replacing engine tools. In order that a cordless power tool has a better use effect, a battery pack is also required to have a higher output characteristic. For example, to achieve a working effect and a battery life similar to those of an engine tool, increasingly high requirements are imposed on the output power, capacity, or charging and discharging rates of the battery pack.

### SUMMARY

A battery pack for powering an outdoor moving device includes: a housing configured to mount to the outdoor moving device and supported by the outdoor moving device; and a cell module mounted in the housing and comprising a plurality of cells. Each one of the plurality of cells is cylindrical and a diameter of the each one of the plurality of cells is greater than or equal to 3 cm.

In an example, the diameter of the each one of the plurality of cells is greater than or equal to 4 cm.

In an example, a length of the each one of the plurality of cells is greater than or equal to 8 cm.

In an example, a ratio of a length of the each one of the plurality of cells to a width of the battery pack is higher than or equal to 0.7.

In an example, a weight of the battery pack is greater than or equal to 9 kg.

In an example, a nominal voltage of the battery pack is higher than or equal to 56 V.

In an example, an average discharging current of the battery pack is greater than or equal to 30 A.

In an example, the plurality of cells are lithium iron phosphate cells.

In an example, the cell module further comprises a bracket, and the bracket comprises a support structure supporting the plurality of cells and further comprises a guide structure guiding the cell module to be mounted in the housing.

In an example, the guide structure is a guide rib.

In an example, the guide structure is a guide groove.

In an example, the guide structure is parallel to a mounting direction of the cell module.

In an example, the guide structure is perpendicular to a length direction of the each one of the plurality of cells.

In an example, the cell module further comprises a plurality of connection pole pieces, each one of the plurality of connection pole pieces is connected to at least two ones of the plurality of cells, the each one of the plurality of connection pole pieces is connected to the at least two ones of the plurality of cells through welding, and a ratio of a welding area to a surface area of the each one of the plurality of connection pole pieces is higher than or equal to 0.1.

In an example, a welding path of the each one of the plurality of connection pole pieces and the at least two ones of the plurality of cells is a closed figure.

An outdoor moving device includes: a battery compartment; and a battery pack accommodated in the battery compartment. The battery pack includes: a housing configured to mount to the battery compartment and supported by the battery compartment; and a cell module mounted in the housing and comprising a plurality of cells. A diameter of each one of the plurality of cells is greater than or equal to 4 cm.

A battery pack for powering an electric device includes: a housing configured to mount to the electric device and supported by the electric device; a cell module comprising a plurality of cells and disposed in the housing; and a terminal assembly electrically connected to the plurality of cells and used for electrically connecting the battery pack to the electric device. A diameter of each one of the plurality of cells is greater than or equal to 3 cm, and a ratio of the diameter of the each one of the plurality of cells to a length of the each one of the plurality of cells is higher than or equal to 0.5.

In an example, a capacity of the battery pack is greater than or equal to 20 Ah, and a ratio of the capacity of the battery pack to a weight of the battery pack is higher than or equal to 2 Ah/kg.

In an example, the plurality of cells are lithium iron phosphate cells.

In an example, the battery pack further includes a handle disposed on the housing and gripped by a user, wherein a ratio of a length of the handle to a length of the battery pack in an extension direction of the handle is higher than or equal to 0.6.

### BRIEF DESCRIPTION OF THE DRAWINGS

FIG. 1 is a perspective view of a battery pack of an example;

FIG. 2 is a perspective view of a battery pack of an example from another angle;

FIG. 3 is a perspective view of a battery pack of an example from another angle;

FIG. 4 is an exploded view of a battery pack of an example;

FIG. 5 is a structural view of a partial housing of a battery pack of an example;

FIG. 6 is a structural view of a terminal assembly of an example;

FIG. 7 is a sectional view of a battery pack of an example;

FIG. 8 is a perspective view of an outdoor moving device of an example;

FIG. 9 is a sectional view of a battery compartment with a battery pack mounted in an example;

FIG. 10a is a sectional view of a battery compartment with no battery pack mounted in an example;

FIG. 10b is a sectional view of a battery compartment with no battery pack mounted in an example;

FIG. 11 is a structural view of a battery compartment with no battery pack mounted in an example;

FIG. 12 is a sectional view of a floating structure in a battery compartment in an example; and

FIG. 13 is a partial circuit diagram of a battery pack in an example.

### DETAILED DESCRIPTION

The present application is described below in detail in conjunction with drawings and examples.

It is to be understood by those skilled in the art that in the disclosure of the present invention, orientations or position relations indicated by terms such as “up”, “down”, “front”, “rear”, “left”, and “right” are based on the drawings. These orientations or position relations are intended only to facilitate and simplify the description of the present invention and not to indicate or imply that an apparatus or element referred to must have such particular orientations or must be configured or operated in such particular orientations. Thus, the terms are not to be construed as limiting the present invention.

The present invention is described below in detail in conjunction with the drawings and the examples.

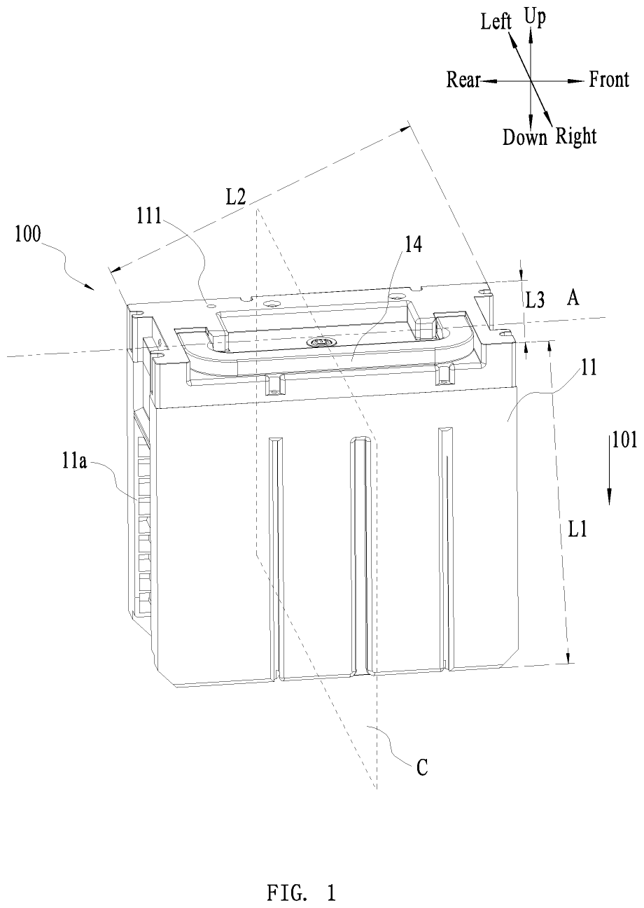

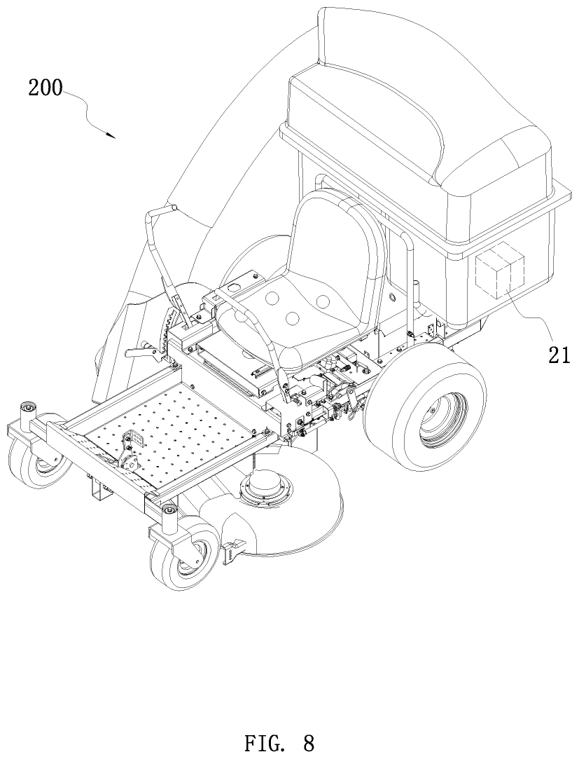

A battery pack 100 shown in FIG. 1 is an energy storage apparatus capable of storing electrical energy to power an electric device. In this example, the electric device may include a large-sized outdoor moving device such as a riding lawn mower and a snow thrower. Alternatively, the electric device may include some energy conversion devices, such as an adapter or an inverter, capable of converting the electrical energy outputted by the battery pack 100 so as to power other small-sized power tools such as handheld power tools and power some household electric devices such as a lamp, a mosquito-killing device, a fan, a cell phone, a computer, and other electric devices in daily lives. In the following examples, an outdoor moving device 200 (as shown in FIG. 8) is used as an important example of the electric device for description, but other types of electric devices are not excluded. For the outdoor moving device, multiple battery packs 100 are usually required, and the multiple battery packs 100 are detachably installed on the outdoor moving device to provide power for the outdoor moving device.

In this example, the weight of the battery pack shown in FIG. 1 is greater than or equal to 9 kg. In an example, the weight of the battery pack is greater than or equal to 10 kg, or greater than or equal to 11 kg, or greater than or equal to 12 kg, or greater than or equal to 13 kg, or greater than or equal to 14 kg, or greater than or equal to 15 kg. For example, the weight of the battery pack is 9 kg, 10 kg, 15 kg, or the like. The nominal voltage of the battery pack 100 is about 56 V. For example, the nominal voltage of the battery pack may be 54 V, 58 V, or the like. In an example, the nominal voltage of the battery pack is higher than or equal to 56 V, or higher than or equal to 50 V, or higher than or equal to 48 V. The capacity of the battery pack 100 is greater than or equal to 20 Ah. In an example, the capacity of the battery pack 100 is greater than or equal to 30 Ah, or greater than or equal to 40 Ah, or greater than or equal to 50 Ah. For example, the capacity of the battery pack 100 may be 20 Ah, 30 Ah, 40 Ah, 50 Ah, or the like. The ratio of the capacity of the battery pack 100 to the weight of the battery pack 100 is higher than or equal to 2 Ah/kg, for example, 2 Ah/kg, 4 Ah/kg, or 5 Ah/kg. The average discharging current of the battery pack 100 is greater than or equal to 30 A. For example, the average discharging current of the battery pack 100 may be 30 A, 35 A, 40 A, or the like. The energy of the battery pack 100 is greater than or equal to 2 kWh. In an example, the energy of the battery pack 100 is greater than or equal to 3 kWh, or greater than or equal to 4 kWh, or greater than or equal to 5 kWh. For example, the energy of the battery pack 100 may be 2 kWh, 3 kWh, 4 kWh, 5 kWh, or the like. In an example, the battery pack 100 is substantially in the shape of a cuboid, which has a height L1 of about 330 mm, a length L2 of about 320 mm to 330 mm, and a width L3 of about 170 mm to 180 mm. In some examples, the nominal voltage of the battery pack is greater than or equal to 40V, or the nominal voltage of the battery pack is greater than or equal to 80V, or the nominal voltage of the battery pack is greater than or equal to 120V. In this example, the height of the battery pack 100 may refer to the size of the battery pack 100 in FIG. 1 along the up-down direction, the length of the battery pack 100 may refer to the size of the battery pack 100 in FIG. 1 along the front-rear direction, the width of the battery pack 100 may refer to the size of the battery pack 100 in FIG. 1 along the left-right direction, a width direction of the battery pack 100 is consistent with a length direction of a cell 131 (as described below), the battery pack 100 is combined to the outdoor walking device 200 along a height direction, and the height direction of the battery pack 100 may be regarded as a combining direction 101 of combining the battery pack 100 to the outdoor walking device 100. In some example, a combining direction in which the battery pack 100 is combined with the outdoor walking device 200 is defined as a height direction, and the width of the battery pack 100 refers to the dimension of the battery pack 100 perpendicular to the height direction. In some example, a direction of the largest size of the battery pack 100 in a three-dimensional coordinate system is defined as a height direction, and directions perpendicular to the height direction are a length direction and a width direction, wherein the size of the battery pack 100 along the length direction is greater than the size of the battery pack 100 along the width direction, so that the width of the battery pack 100 may be understood as the size of the battery pack 100 in the width direction at this time. It can be understood that the width of the battery pack 100 can also be understood as the size of the battery pack 100 in any one of the length direction, width direction and height direction.

In fact, any battery pack 100 which adopts the essence of the technical solutions of the present application described below or any electric device powered by the battery pack 100 belongs to the scope of the present application.

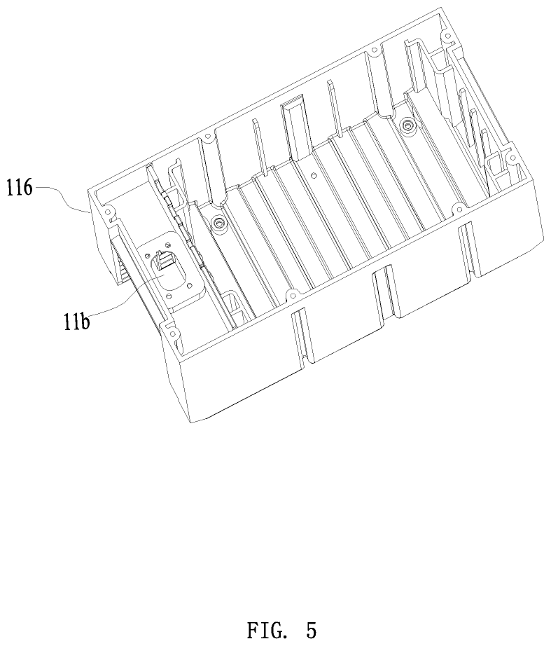

As shown in FIGS. 1 to 6, the battery pack 100 includes a housing 11, a terminal assembly 12, and a cell module 13. The housing 11 forms the body of the battery pack 100 and is substantially in the shape of the cuboid. The housing 11 is formed with an accommodating cavity for accommodating the cell module 13. In an example, the housing 11 may include an upper cover, a barrel, and a lower cover which are capable of constituting the accommodating cavity substantially closed. The housing 11 may include a left housing and a right housing, an upper and a lower housing, or housings assembled in another form. A terminal assembly 12 is mounted on the housing 11, and the battery pack 100 is electrically connected to the electric device through the terminal assembly 12 to power the electric device. In an example, one or more exhaust valves 111 may be disposed on the upper surface of the housing 11 or a side surface of the housing 11 so that the flow of gas is formed between the accommodating cavity and the outside. In an example, the area of the exhaust valve 111 is larger than or equal to 5 mm2, and the exhaust valve 111 may be a one-way valve and include a polymer membrane. Liquid collection slots 112 are formed in the bottom surface of the housing 11. A liquid collection slot 112 can collect a liquid in the accommodating cavity, where the liquid may be a liquid flowing out of a damaged cell 121 in the cell module 13 or may be a liquid formed through the liquefaction of a gas in the accommodating cavity. In an example, the areas of the liquid collection slots 112 on a section of the battery pack are greater than or equal to 20 cm². For example, the areas of the liquid collection slots 112 on the section formed along the front and rear direction of the battery pack may be 20 cm², 25 cm², 30 cm², or the like. In other examples, wheels may be detachably disposed under the housing 11 to support the housing 11 so that a user can move the battery pack 100 with less effort.

To facilitate the operation of the user, a handle assembly 14 may also be disposed on the housing 11 so that it is convenient for the user to lift the battery pack 100. In an example, the handle assembly 14 may include one or more handles 141. For example, the handle assembly 14 may include two separate handles 141 which may be disposed on the same surface of the housing 11 or different surfaces of the housing 11 separately. In an example, the ratio of the length of the handle 141 to the length of the battery pack 100 in the extension direction A of the handle 141 is higher than or equal to 0.6. In an example, the ratio of the length of the handle 141 to the length of the battery pack 100 in the extension direction A of the handle 141 is higher than or equal to 0.7, or higher than or equal to 0.8, or higher than or equal to 0.9. For example, the ratio of the length of the handle 141 to the length of the battery pack 100 in the extension direction A of the handle 141 is 0.6, 0.7, 0.8, 0.9, or 1. In an example, the handle 141 and the housing 11 may be integrally formed. In an example, the handle 141 is detachably mounted on a surface of the housing 11. For example, the upper surface of the housing 11 is recessed inward to form a square first slot, a circular first slot, or a first slot of another shape (not shown). The handle 141 may be fixed to a slot wall of the first slot by pins and is rotatable about the pins by an angle of approximately 180° on the housing 11. In other words, when not lifted for use, the handle 141 may be stored in the first slot so that the dimension of the battery pack 100 can be reduced. Thus, the battery pack 100 is placed in the electric device. Another storage portion formed or mounted on the housing 11 and used for storing the handle 141 without increasing the volume of the battery pack is also within the scope of this example. In an example, elastic reset members (not shown) may be disposed at the joints of the handle 141 and the housing 11, and the handle 141 may be reset into the first slot when the handle 141 is not lifted.

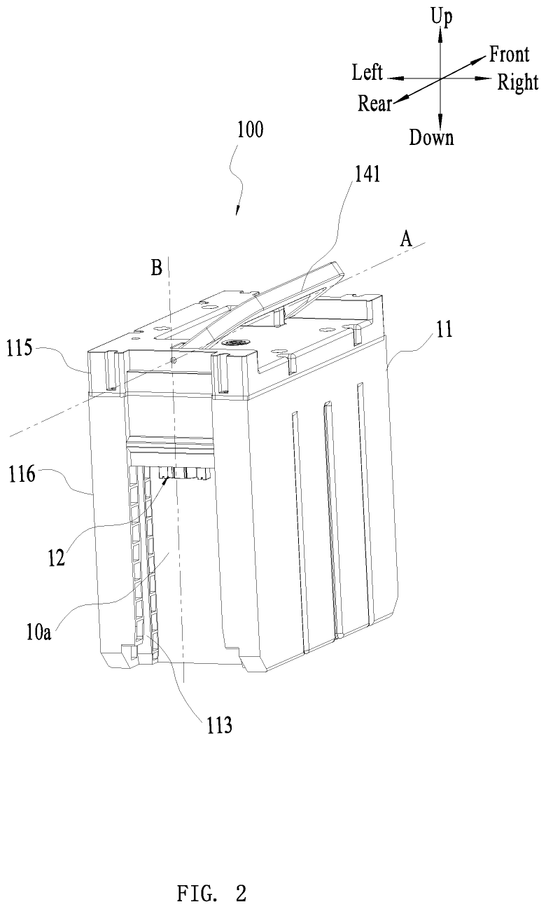

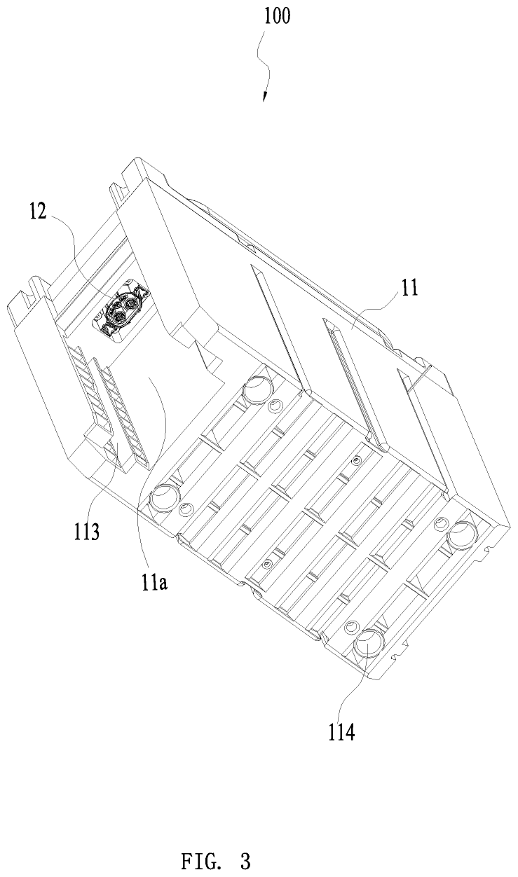

Referring to FIGS. 2 and 3, mounting rails 113 may be disposed on a side surface of the housing 11 and can guide the battery pack 100 when the battery pack 100 is mounted on the outdoor moving device. In an example, a second slot 11a whose shape is similar to an inverted “U” is disposed on at least one side surface of the housing 11, where the second slot 11a includes two opposite slot sidewalls and a top-end wall, and the opening of the second slot 11a faces the underneath of the battery pack 100. At least one slot sidewall of the second slot 11a is recessed inward so that a mounting rail 113 can be formed. In an example, the extension direction B of the mounting rail 113 is substantially perpendicular to the extension direction A of the at least one handle 141. It is to be understood that the extension direction B of the mounting rail 113 coincides with the extension direction of the second slot 11a. In an example, the ratio of the length of the second slot 11a in the extension direction B to the length of the battery pack 100 in the extension direction B is higher than or equal to 0.5. For example, the ratio may be 0.5, 0.6, 0.7, 0.8, 0.9, or the like. In an example, a slot similar to the second slot 11a may also be disposed below the battery pack 100 and is used for implementing the guidance of the bottom of the battery pack 100.

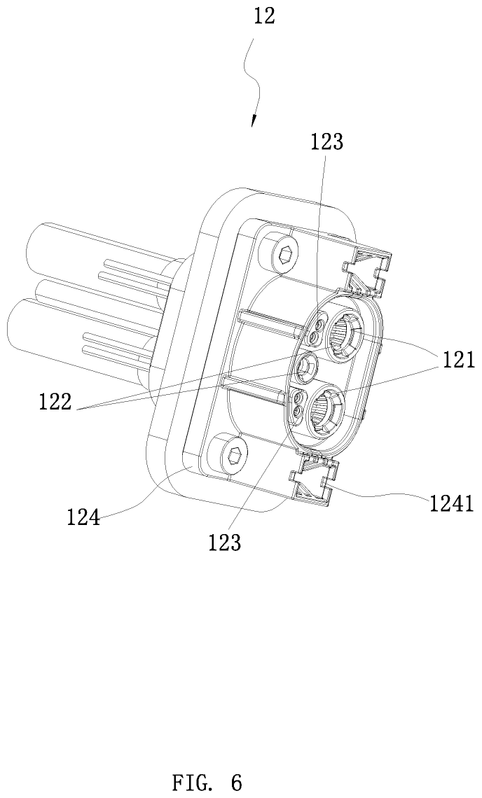

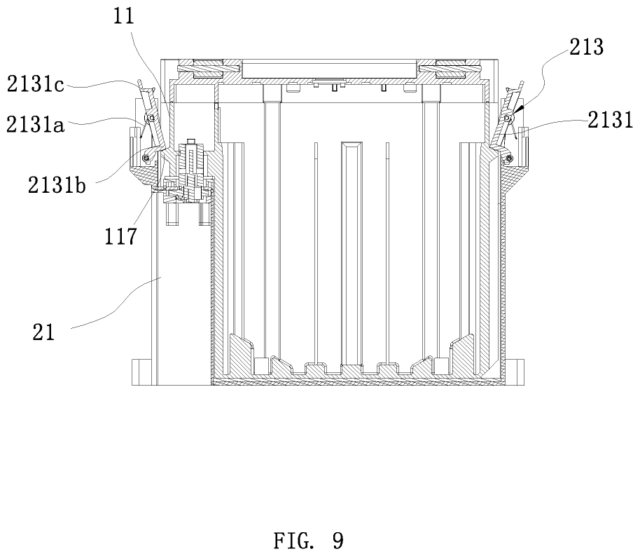

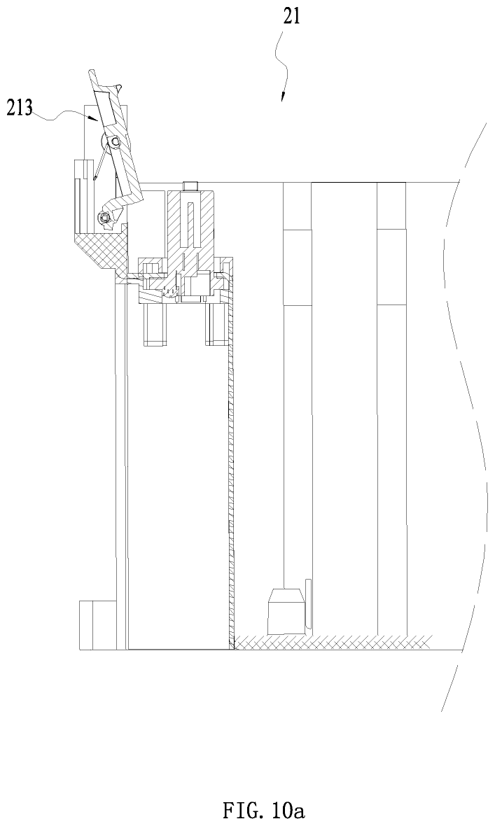

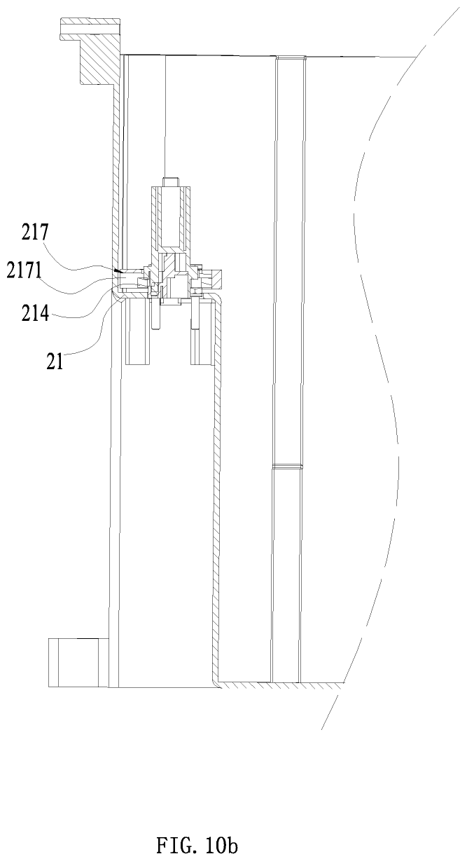

A terminal assembly 12 is mounted at the top end of at least one second slot 11a. The distance from the terminal assembly 12 to the bottom surface of the battery pack 100 is greater than or equal to 3 cm, the distance from the terminal assembly 12 to the bottom surface of the battery pack 100 is greater than or equal to 4 cm, or the distance from the terminal assembly 12 to the bottom surface of the battery pack 100 is greater than or equal to 5 cm. In an example, the housing 11 is provided with a terminal mounting hole 11b, and the terminal assembly 12 may be mounted on the housing 11 by the terminal mounting hole 11b. In an example, the terminal assembly 12 is not higher than slot walls of the second slot 11a along the extension direction A of the handle 141. The terminal assembly 12 may be externally connected to a device terminal on a self-moving device so that the battery pack 100 powers the device, or the terminal assembly 12 may be connected to a terminal on the adapter or a terminal on the inverter so that the battery pack 100 is charged. In an example, as shown in FIG. 6, the terminal assembly 12 may include positive/negative charging terminals 121, positive/negative discharging terminals 122, and communication terminals 123. The positive/negative charging terminals 121, the positive/negative discharging terminals 122, and the communication terminals 123 may be cylindrical metal terminals, sheet-shaped metal terminals, or conductive terminals of other shapes. Optionally, a positive charging terminal and a positive discharging terminal in the terminal assembly 12 may be the same terminal, or a negative charging terminal and a negative discharging terminal in the terminal assembly 12 may be the same terminal. When the battery pack is charged or discharged, the communication terminals may be shared for the communication with the adapter or the self-moving device. In an example, insulating caps may be disposed on the positive/negative charging terminals 121, the positive/negative discharging terminals 122, or the communication terminals 123. There is a hole in the middle of an insulating cap so that the metal charging terminals and the metal discharging terminals can be electrically connected to terminals on the tool. In an example, the positive/negative charging terminals 121, the positive/negative discharging terminals 122, and the communication terminals 123 may be arranged in the manner shown in FIG. 6 according to actual design requirements. In an example, to be matched with charging terminals, discharging terminals, and communication terminals in a compartment body terminal assembly 214 in a battery compartment 21 in FIGS. 9a to 10, the positive/negative charging terminals 121, the positive/negative discharging terminals 122, and the communication terminals 123 may be configured to be arranged in the same manner as the manner in which the terminals in FIGS. 9a to 10 are arranged.

With continued reference to FIG. 6, the terminal assembly 12 may include a terminal block 124. The positive/negative charging terminals 121, the positive/negative discharging terminals 122, and the communication terminals 123 are disposed on the terminal block 124. Guide structures 1241 are further disposed on the terminal block 124, or the terminal block 124 can form guide structures 1241. Corresponding structures matched with the guide structures 1241 are disposed on the power tool. After the guide structures 1241 mate with the corresponding structures on the tool, the terminal assembly 12 can float within a preset distance range. Thus, the case can be avoided where the connection terminals are connected unstably or damaged due to uncontrollable factors such as vibration after the battery pack 100 is mounted on the tool. In an example, a guide structure 1241 may be a guide column and a corresponding structure on the tool mating with the guide column may be a guide groove, or the guide structure 1241 is a guide groove and a guide column is disposed on the tool. In an example, a preset distance which the terminal assembly 12 may float is less than or equal to 2 cm. In an example, guide columns on the terminal block 124 are higher than the positive/negative charging terminals 121, the positive/negative discharging terminals 122, and the communication terminals 123. The positive/negative charging terminals 121, the positive/negative discharging terminals 122, and the communication terminals 123 in the terminal assembly 12 can be electrically connected to the cell module 13.

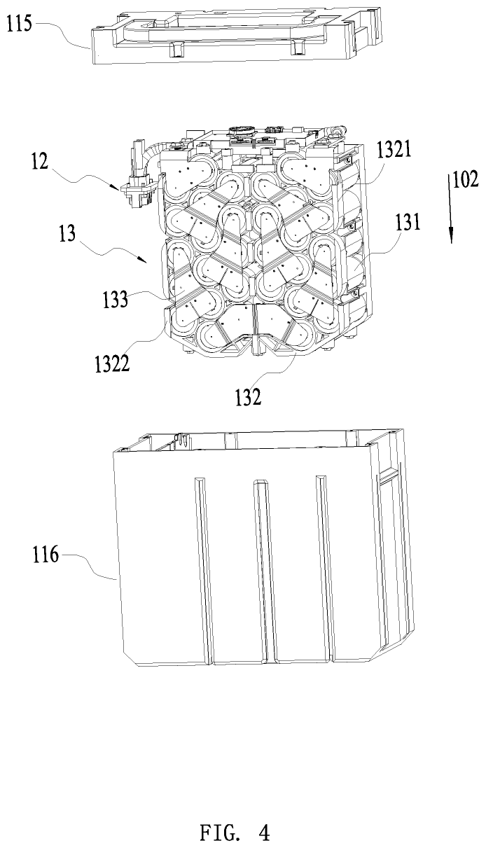

As shown in FIG. 4, the cell module 13 may be constituted by multiple cells 131 connected in series and/or connected in parallel. In this example, a cell 131 may be a cylindrical cell, and the diameter of the cell 131 is greater than or equal to 3 cm, for example, the diameter of the cell 131 is 3 cm, 3.5 cm, 4 cm, or the like. In an example, the diameter of the cell 131 is greater than or equal to 4 cm, for example, the diameter of the cell 131 may be 4.5 cm, 4.6 cm, 5 cm, or the like. In this example, the height of the cell 131 is greater than or equal to 8 cm, for example, the height of the cell 131 is 8 cm, 9 cm, 10 cm, 11 cm, 12 cm, 13 cm, 13.5 cm, or the like. In an example, the ratio of the length of the cell 131 to the width of the battery pack 100 is higher than or equal to 0.7 or 0.8. In an example, the ratio of the diameter of the cell 131 to the length of the cell 131 is higher than or equal to 0.5, or higher than or equal to 0.6, or higher than or equal to 0.7.

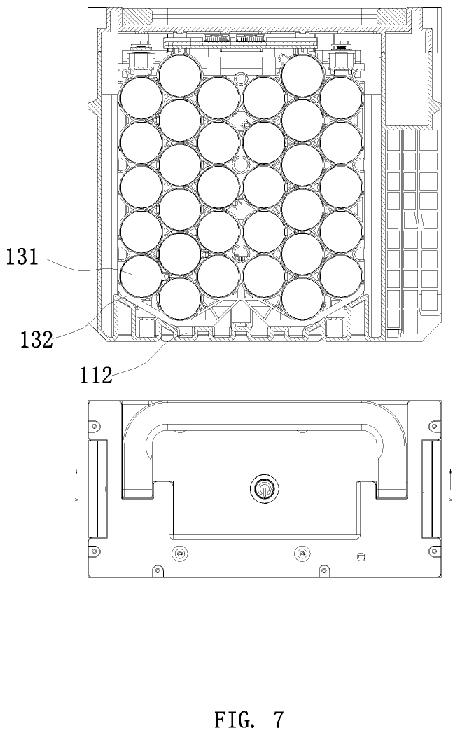

In this example, the multiple cells 131 may be lithium iron phosphate batteries. In an example, the cells 131 may be manganese phosphate ion cells or sodium ion cells. With continued reference to FIG. 4, the cell module 13 may also include a bracket 132, and the bracket 132 may be fixed to the housing 11 by screws. In an example, the bracket 132 may be constituted by two sub-brackets which are detachable and substantially symmetrical, and the two sub-brackets may be fixed by the screws. In an example, the bracket 132 includes a support structure 1321 supporting the multiple cells 131 and a guide structure 1322 capable of guiding the cell module 13 to be mounted in the housing 11. In an example, the guide structure 1322 is a guide rib or a guide groove. In an example, the guide structure 1322 is parallel to the mounting direction 102 of the cell module 13, and the mounting direction 102 of the cell module 13 refers to a stacking direction of the multiple cells 131 in the battery module 13, that is to say, the multiple cells 131 are stacked sequentially along the mounting direction 102. In an example, the guide structure 1322 is perpendicular to the length direction of the cell 131. Referring to FIG. 7, the liquid collection slots 112 formed in the bottom surface of the housing 11 are in contact with the bottom of the bracket 132 so that a liquid flowing down the bracket 132 can be collected.

In an example, as shown in FIG. 1, the handle assembly 14 may include the handle 141 disposed on the battery pack, and the handle 141 can be symmetrical about a midplane C. In this example, the vertical distance between the center of gravity of the battery pack 100 and the midplane C is less than or equal to twice the diameter of the cell 131.

In an example, the housing 11 may include at least a first housing 115 and a second housing 116, where the first housing 115 and the second housing 116 may be assembled together in a snap-fit manner to constitute a complete housing 11. In some examples, the first housing 115 may be the upper housing of the battery pack 100 and the second housing 116 may be the lower housing of the battery pack 100. Alternatively, the number of separate housings into which the battery pack 100 can be disassembled is equal to the number of corresponding parts. In this example, the gap between the first housing 115 and the second housing 116 can be filled with a first sealing structure. The first sealing structure may be at least one of a sealant, a sealing ring, or a sealing sponge. In this example, the first housing 115 and the second housing 116 are made of the same material. In an example, the first housing 115 and the second housing 116 are made of different materials. In some examples, different sealing structures may be selected according to the material of the housing 11. That is to say, if the materials of the housing 11 are different, sealing structures to be filled between the first housing 115 and the second housing 116 may be different so that better sealing performance between the two housings can be ensured.

In an example, the terminal assembly 12 is mounted on the housing 11, where one end of the terminal assembly 12 can be disposed in the housing 11, and the other end of the terminal assembly 12 is exposed outside the housing 11. Therefore, a mounting gap may exist between the terminal assembly 12 and the housing 11. The gap between the terminal assembly 12 and the housing 11 may be filled with a second sealing structure. The second sealing structure is different from the first sealing structure, and the second sealing structure may be at least one of the sealant, the sealing ring, or the sealing sponge.

With continued reference to FIG. 4, the cell module 13 may further include multiple connection pole pieces 133, and each connection pole piece 133 can electrically connect at least two cells 131. In an example, the connection pole piece 133 is connected to the cells 131 through welding, and the ratio of welding areas to the surface area of the connection pole piece 133 is higher than or equal to 0.1. That is to say, the welding areas between the connection pole piece 133 and the cells 131 account for 10% or more of the surface area of the connection pole piece. In an example, the ratio of the welding areas to the surface area of the connection pole piece 133 is higher than or equal to 0.2, or higher than or equal to 0.3, or higher than or equal to 0.4, or higher than or equal to 0.5. In an example, the welding path between the connection pole piece 133 and the cells 131 is a closed figure such as a circle, a square, a polygon, or any other figure. In an example, the connection pole piece 133 and the cells 131 may be connected through multiple-point welding so that the weld path between the connection pole piece 133 and the cells 131 includes multiple discrete welding points. The connection between the connection pole piece 133 and the cells 131 is implemented in the preceding manner. Thus, even if the cells 131 have relatively large dimensions, the stability of the connection between the cells 131 and the connection pole piece 133 can be ensured.

In an example, a group of cells 131 connected together by the connection pole piece 133 is referred to as a battery unit, and each battery unit may be connected to two pole pieces, that is, a positive pole piece and a negative pole piece. The positive pole piece is connected to the positive pole of each cell 131 in the battery unit and can be electrically connected to a positive charging/discharging terminal. The negative pole piece is connected to the negative pole of each cell 131 in the battery unit and can be electrically connected to a negative charging/discharging terminal. The distance between a pair of connection pole pieces 133 connecting the positive pole of a battery unit to the negative pole of the battery unit along the extension direction of the cell 131 is greater than or equal to the length of the cell 131. In an example, the minimum distance between the pair of connection pole pieces 133 connecting the positive pole of the battery unit to the negative pole of the battery unit is greater than or equal to 7 cm, or greater than or equal to 8 cm, or greater than or equal to 9 cm.

As shown in FIGS. 8 to 11, the battery compartment 21 may be included in the power tool or a charger, in FIG. 8, the electric tool takes the above-mentioned outdoor moving device 200 as an example. The battery pack 100 can be accommodated in the battery compartment 21. The battery compartment 21 may include a compartment body 211 and first positioning portions 212 disposed on the inner side of the bottom end of the compartment body 211. The battery pack 100 is accommodated in the compartment body 211, and the mounting rails 113 have a guiding function when the battery pack 100 is mounted to the compartment body 211. In an example, second positioning portions 114 are further disposed on the outer side of the bottom end of the housing 11 of the battery pack. After the battery pack 100 is mounted in the battery compartment 21, the first positioning portions 212 and the second positioning portions 114 can mate with each other to position the battery pack 100, thereby preventing the battery pack 100 from shaking in the compartment body 211. In an example, a first positioning portion 212 may be a raised structure, and a second positioning portion 114 may be a recessed structure corresponding to the raised structure. For example, the first positioning portion 212 may be a raised cylinder, and the second positioning portion 114 may be a cylindrical recessed slot. Alternatively, a first positioning portion 212 may be a recessed structure, and a second positioning portion 114 may be a corresponding raised structure. In an example, the first positioning portion 212 and the second positioning portion 114 constitute a pair of positioning assemblies, and one or more pairs of positioning assemblies may be disposed in the battery pack 100 and the compartment body 211. The number of positioning assemblies may be determined according to the contour shape of the battery pack 100 or the battery compartment 21. For example, the battery pack 100 is in the shape of the cuboid, and four pairs of positioning assemblies may be disposed based on four corners of the bottom surface of the cuboid.

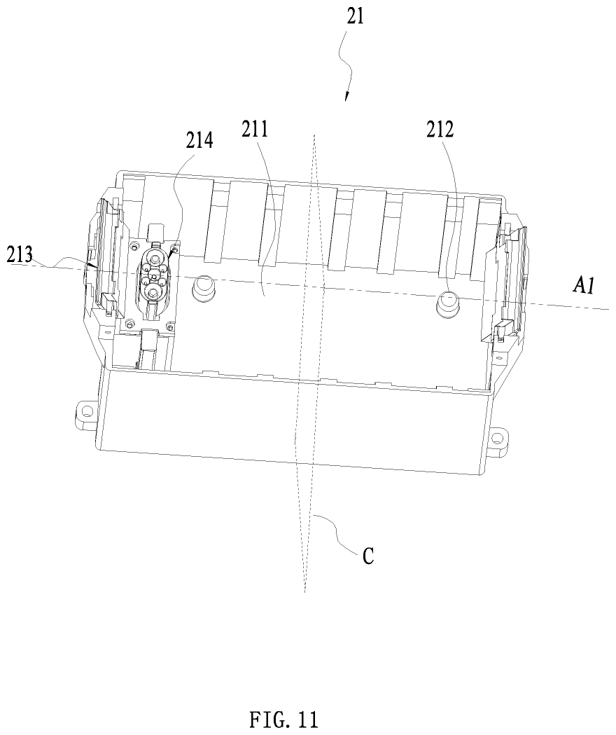

In an example, the battery compartment 21 may further include a locking assembly 213 disposed on the compartment body 211 and capable of locking the battery pack 100 in the compartment body 211. In an example, the locking assembly 213 has at least two locking portions 2131 separately disposed. In an example, the two locking portions 2131 may be symmetrically disposed at the opening of the battery compartment 21. For example, the locking portions 2131 are symmetrically disposed on two side surfaces along the length direction A1 of the compartment body 211 separately. The length direction A1 of the compartment body 211 coincides with the front and rear direction of the battery pack 100 in FIG. 1. In other words, the length direction A1 of the compartment body 211 coincides with the extension direction A of the handle 141 after the battery pack 100 is mounted to the compartment body 211. Referring to FIG. 11, in a direction perpendicular to the length direction A1, the compartment body 211 has a first center plane C1 by which the compartment body 211 is substantially divided into two average parts along the direction perpendicular to A1. In this example, after the battery pack 100 is mounted to the compartment body 211, the first center plane C1 is substantially parallel to or substantially coincides with the midplane C of the handle 141 in the battery pack 100. It is to be understood that the two locking portions 2131 are located on two sides of the first center plane C1 separately and the distances from the two locking portions 2131 to the first center line C1 are substantially the same. In this example, the compartment body terminal assembly 214 and the two locking portions 2131 are substantially in the same direction, for example, substantially in the direction A1. The distance between the compartment body terminal assembly 214 and one of the locking portions 2131 is less than the distance from the compartment body terminal assembly 214 to the first center plane C1. Thus, after the battery pack 100 is mounted to the compartment body 211, the locking portion 2131 is close to the terminal assembly 12. After the locking portions 2131 lock the battery pack 100 and the compartment body 211, the terminal assembly 12 of the battery pack 100 and the compartment body terminal assembly 214 in the battery compartment 21 can be coupled to each other more closely.

It is to be noted that the distance from the locking portion 2131 to the compartment body terminal assembly 214 may be understood as the distance from any positional point of the locking portion 2131 to any positional point of the compartment body terminal assembly 214 in the direction A1. In an example, the locking portion 2131 includes multiple components (such as an elastic member 2131a, a stopper portion 2131b, and a rotary toggle 2131c described below), and the compartment body terminal assembly 214 also includes multiple components (not shown). When a connection line between any positional point on any component of the locking portion 2131 and any positional point on any component of the compartment body terminal assembly 214 is parallel to the direction A1, the distance between the two points may be understood as the distance from the locking portion 2131 to the compartment body terminal assembly 214. The distance from the compartment body terminal assembly 214 to the first center plane C1 may be understood as the distance from any positional point on the compartment body terminal assembly 214 to the first center plane C1.

In an example, each locking portion 2131 has a first state and a second state. When the battery pack 100 is retained in the battery compartment 21 and the battery pack 100 is completely disengaged from the battery compartment 21, the locking portion 2131 is in the second state. In the process where the battery pack 100 is inserted into the battery compartment 21, the locking portion 2131 is in the first state. It is to be understood that when the locking portion 2131 is in the first state, relevant structures of the locking portion 2131 change as the battery pack 100 continuously enters the compartment body 211 until the battery pack 100 no longer moves with respect to the compartment body 211.

In an example, the housing 11 of the battery pack is provided with mating portions 117 capable of mating with the locking portions 2131 to retain the battery pack 100 in the compartment body 211. In an example, a mating portion 117 may be a prismatic structure or a cylindrical structure formed by the raised housing 11. For example, the mating portion 117 may be a prism with a trapezoidal or triangular cross section, where a longer side of two parallel sides of the trapezoid is formed on the housing 11 or one side of the triangle is formed on the housing 11. That is to say, the mating portion 117 has two inclined surfaces so that the battery pack 100 can be conveniently mounted to or removed from the compartment body 211.

As shown in FIG. 9, the locking portion 2131 includes at least the elastic member 2131a, the stopper portion 2131b, and the rotary toggle 2131c. The elastic member 2131a may be a spring member disposed on a rotating shaft of the locking portion 2131. Two ends of the spring clip extend to be capable of abutting against a wall of the compartment body, and the locking portion 2131 is rotatable about the rotating shaft. Assuming that the battery pack 100 is not mounted to the compartment body 211, the elastic member 2131a is in a relaxed state, that is, the elastic member 2131a is not pressed and substantially has no elastic force. In this case, the locking portion 2131 is in the second state and the stopper portion 2131b is in an initial state. In the process where the battery pack 100 is mounted to the compartment body 211 from top to bottom, the lower inclined surface of the mating portion 117 is in contact with the upper surface of the stopper portion 2131b. As the battery pack 100 continues moving downward, the mating portion 117 can push the stopper portion 2131b outward, the elastic member 2131a is continuously compressed, and the locking portion 2131 is in the first state. After the mating portion 117 continues moving downward and passes the stopper portion 2131b, the elastic member 2131a can release the elastic force instantaneously or within a short time to push the stopper portion 2131b inward to the initial position, and the locking portion 2131 is restored to and retained in the second state, that is, the state shown in FIG. 9. Thus, the lower surface of the stopper portion 2131b can abut against the upper inclined surface of the mating portion 117. The battery pack 100 cannot move upward without the intervention of an external force, thereby preventing the battery pack 100 from shaking up and down in the compartment body 211. That is to say, the user may move the stopper portion 2131b outward away from the mating portion 117 by pushing the rotary toggle 2131c to rotate the locking portion 2131 about the rotating shaft so that the user can remove the battery pack 100 from the compartment body 211. Referring to FIG. 10, after the battery pack 100 is removed from the compartment body 211, the state of the locking portion 2131 coincides with the state shown in FIG. 9.

As shown in FIG. 10b, the battery compartment 21 may also include a terminal cover 217 which can accommodate part of the compartment body terminal assembly 214 and retains the compartment body terminal assembly 214 on the battery compartment 21 in a floatable manner. That is to say, an accommodating space 2171 can be formed between the terminal cover 217 and the compartment body 211 so that part of the structure of the compartment body terminal assembly 214 is movable in a small range in a horizontal direction or a vertical direction within the accommodating space 2171. Thus, when the battery pack 100 is placed or when the battery pack 100 vibrates in the battery compartment 21 to deviate up and down, vertically, from side to side, or horizontally, a displacement of the deviation can be accommodated by the preceding accommodating space 2171 so that damage to the compartment body terminal assembly 214 and surrounding connectors is reduced, thereby improving the reliability thereof.

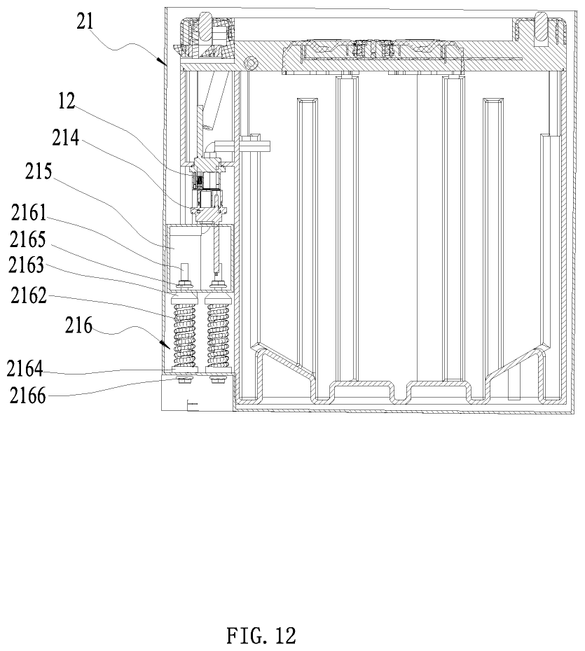

In an example, as shown in FIG. 12, a floating block 215 is further included in the battery compartment 21, where one end of the floating block 215 is connected to the compartment body terminal assembly 214 and the other end of the floating block 215 is connected to the battery compartment 21 by at least one floating structure 216. The floating structure 216 may include guide structures 2161 which can penetrate between the floating block 215 and the compartment body 21, springs 2162 sleeved on the guide structures 2161, conical bodies 2163 which can be disposed at the upper ends of the springs 2162, and bottom cover plates 2164 which can be disposed at the lower ends of the springs 2162. In an example, the floating structure 216 further includes top cover plates 2165 and bottom pressing plates 2166, where after the floating structure is mounted between the floating block 215 and the battery compartment 21, the top cover plates 2165 are fixed at the uppermost ends of the guide structures 2161 and can retain the connection between the floating structure 216 and the floating block 215, and the bottom pressing plates 2166 are fixed at the lowermost ends of the guide structures 2161 and can retain the connection between the floating structure 216 and the battery compartment 21.

In this example, the floating structure 216 may limit the floating block 215 through the top cover plates 2165 at the upper ends to prevent the floating block 215 from completely disengaging from the conical bodies 2163. The floating structure 216 may press the battery compartment 21 through the bottom pressing plates 2166 and the bottom cover plates 2164 at the lower ends. When the battery pack 100 is placed or when the battery pack 100 vibrates in the battery compartment 21 to deviate up and down or vertically, the amount of the deviation may be absorbed by the springs 2162. When the battery pack 100 is placed or the battery pack 100 vibrates in the battery compartment 21 to deviate from side to side or horizontally, part of the floating block 215 deviates horizontally and can drive the conical bodies 2163 to move in an up and down direction so that the springs 2162 are moved in the up and down direction to absorb the amount of the deviation. In summary, when the battery pack 100 deviates or vibrates, the amount of the deviation may be absorbed by the floating structure 216 so that the damage to the compartment body terminal assembly 214 and the surrounding connectors is reduced, thereby improving the reliability thereof.

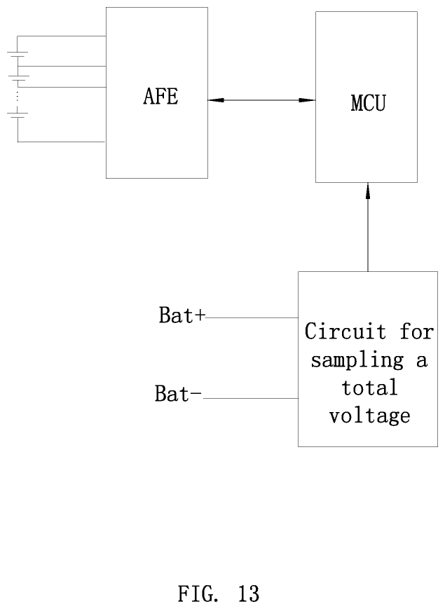

In an example, as shown in FIG. 13, a detection unit 15 and a control unit 16 are further disposed in the battery pack 100. In this example, the detection unit 15 may be an active front end (AFE). The control unit 16 may be a microcontroller unit (MCU). In this example, the AFE can perform single-cell detection on the multiple cells 121. That is, a cell parameter of each cell 121 is detected separately, for example, a voltage, a current, a temperature, or the like of a single cell 121 can be detected. The MCU can control the charging/discharging states of the multiple cells 121 and can also collect the total voltage of the battery pack 100. The AFE and the MCU may be disposed on the same circuit board or may be disposed on different circuit boards separately.

In an example, the AFE may be communicatively connected to the MCU so that the AFE and the MCU can perform data interaction. The AFE may perform a bidirectional reset function with the MCU, that is, the AFE can reset the MCU and the MCU can reset the AFE. For example, the MCU may acquire a cell parameter detected by the AFE and can also collect another battery pack parameter of the battery pack and compare the preceding cell parameter with the battery pack parameter to confirm whether the AFE is abnormal. If the AFE is abnormal, the AFE is controlled to be reset. For example, the cell parameter is a voltage of the single cell 121, and the battery pack parameter is the total voltage of the battery pack. According to the total voltage of the battery pack, the voltage of the single cell, or the total number of cells, the MCU may determine whether the AFE is abnormal. If it is determined that the AFE is abnormal, it is considered that a first preset condition is met, thereby controlling the AFE to be reset. In an example, in the process where the AFE performs the data interaction with the MCU, the AFE may determine whether the MCU is abnormal according to whether communication data sent by the MCU is received within preset time. If the communication data sent by the MCU is not received within the preset time, it is considered that a second preset condition is met, thereby controlling the MCU to be reset.

The basic principles, main features, and advantages of the present application are shown and described above. It is to be understood by those skilled in the art that the preceding examples do not limit the present application in any form, and all technical solutions obtained through equivalent substitutions or equivalent transformations fall within the scope of the present application.

What is claimed is:

1. A battery pack for powering an outdoor moving device, comprising:
a housing configured to mount to the outdoor moving device and supported by the outdoor moving device; and
a cell module mounted in the housing and comprising a plurality of cells;
wherein each one of the plurality of cells is cylindrical and a diameter of the each one of the plurality of cells is greater than or equal to 3 cm.

2. The battery pack according to claim 1, wherein the diameter of the each one of the plurality of cells is greater than or equal to 4 cm.

3. The battery pack according to claim 1, wherein a length of the each one of the plurality of cells is greater than or equal to 8 cm.

4. The battery pack according to claim 1, wherein a ratio of a length of the each one of the plurality of cells to a width of the battery pack is higher than or equal to 0.7.

5. The battery pack according to claim 1, wherein a weight of the battery pack is greater than or equal to 9 kg.

6. The battery pack according to claim 1, wherein a nominal voltage of the battery pack is higher than or equal to 56 V.

7. The battery pack according to claim 1, wherein an average discharging current of the battery pack is greater than or equal to 30 A.

8. The battery pack according to claim 1, wherein the plurality of cells are lithium iron phosphate cells.

9. The battery pack according to claim 1, wherein the cell module further comprises a bracket, and the bracket comprises a support structure supporting the plurality of cells and further comprises a guide structure guiding the cell module to be mounted in the housing.

10. The battery pack according to claim 9, wherein the guide structure is a guide rib.

11. The battery pack according to claim 9, wherein the guide structure is a guide groove.

12. The battery pack according to claim 9, wherein the guide structure is parallel to a mounting direction of the cell module.

13. The battery pack according to claim 9, wherein the guide structure is perpendicular to a length direction of the each one of the plurality of cells.

14. The battery pack according to claim 1, wherein the cell module further comprises a plurality of connection pole pieces, each one of the plurality of connection pole pieces is connected to at least two ones of the plurality of cells, the each one of the plurality of connection pole pieces is connected to the at least two ones of the plurality of cells through welding, and a ratio of a welding area to a surface area of the each one of the plurality of connection pole pieces is higher than or equal to 0.1.

15. The battery pack according to claim 14, wherein a welding path of the each one of the plurality of connection pole pieces and the at least two ones of the plurality of cells is a closed figure.

16. An outdoor moving device, comprising:
a battery compartment; and
a battery pack accommodated in the battery compartment;
wherein the battery pack comprises:
a housing configured to mount to the battery compartment and supported by the battery compartment; and
a cell module mounted in the housing and comprising a plurality of cells;
wherein a diameter of each one of the plurality of cells is greater than or equal to 4 cm.

17. A battery pack for powering an electric device, comprising:
a housing configured to mount to the electric device and supported by the electric device;
a cell module comprising a plurality of cells and disposed in the housing; and
a terminal assembly electrically connected to the plurality of cells and used for electrically connecting the battery pack to the electric device;
wherein a diameter of each one of the plurality of cells is greater than or equal to 3 cm, and a ratio of the diameter of the each one of the plurality of cells to a length of the each one of the plurality of cells is higher than or equal to 0.5.

18. The battery pack according to claim 17, wherein a capacity of the battery pack is greater than or equal to 20 Ah, and a ratio of the capacity of the battery pack to a weight of the battery pack is higher than or equal to 2 Ah/kg.

19. The battery pack according to claim 17, wherein the plurality of cells are lithium iron phosphate cells.

20. The battery pack according to claim 17, further comprising a handle disposed on the housing and gripped by a user, wherein a ratio of a length of the handle to a length of the battery pack in an extension direction of the handle is higher than or equal to 0.6.
